(19) United States
(12) Patent Application Publication
(10) Pub. No.: US 2022/0131129 A1
(43) Pub. Date: Apr. 28, 2022

(54) METHOD AND APPARATUS FOR PRODUCING TERNARY CATHODE MATERIAL

(71) Applicant: Linde GmbH, Pullach (DE)

(72) Inventors: Edward FENG, Pullach (DE); Rocky WEI, Pullach (DE)

(21) Appl. No.: 17/310,793

(22) PCT Filed: Feb. 26, 2019
(86) PCT No.: PCT/CN2019/076111

§ 371 Date: Aug. 24, 2021

(51) Int. Cl. H01M 4/04; B01J 19/26; F27D 7/02

(52) U.S. Cl. CPC H01M 4/0471; H01M 2004/028; F27D 7/02; B01J 19/26

(57) ABSTRACT

A method for producing a ternary cathode material for lithium batteries by roasting raw material in a roasting kiln, wherein an atmosphere is provided in the roasting kiln, wherein injection of a gas component of the atmosphere into the roasting kiln is controlled in closed loop control manner, based on at least one process influencing parameter being measured, as well as an apparatus for producing a ternary cathode material.

### TECHNICAL FIELD

The invention relates to a method and an apparatus for producing a ternary cathode material for lithium batteries by roasting raw material in a roasting kiln

### PRIOR ART

The market for electric and hybrid vehicles is growing fast. This creates an increasing demand for lithium or lithium ion batteries which are typically used in the automotive industry. Lithium batteries contain cathode material and anode material among other components. The processes to produce these materials and their components typically use gases like oxygen, nitrogen and argon.

Due to the demand for long range electric and hybrid vehicles, there is a demand to lithium batteries industry to seek higher energy ratio cathode materials and corresponding solutions. So-called ternary cathode materials with higher energy density have become a trend in that industry. Such ternary cathode materials for lithium batteries are typically produced by roasting raw material in a roasting kiln, providing an atmosphere in the roasting kiln.

The present invention aims at improving the possibilities to obtain products from raw materials being roasted in a roasting kiln and thus providing better lithium batteries.

### DISCLOSURE OF THE INVENTION

This object is achieved by providing a method and an apparatus according to the independent claims.

A method according to the invention serves for producing a ternary cathode material for lithium batteries (or lithium ion batteries) by roasting raw material in a roasting kiln, wherein an atmosphere is provided in the roasting kiln. A continue roller hearth kiln or a pusher kiln are preferably used as the roasting kiln. Typical and also preferred ternary cathode materials are nickel cobalt manganese and nickel cobalt aluminum. Typical temperatures used for such roasting processes are between 700° C. and 1000° C. the roasting process typically lasting between 10 and 18 hours.

The chemical reaction occurring in that roasting process can be described by the following formulas, wherein M represents M (nickel), Mn (manganese), Co (cobalt) and/or Al (aluminum):

$${M ( OH )}_{2} + 0.5 {Li}_{2} {CO}_{3} + 0.25 {O}_{2} = {Li M O}_{2} + 0.5 {CO}_{2} + {H}_{2} O$$

$${M ( OH )}_{2} + LiOH . {H}_{2} O + 0.25 {O}_{2} = {Li M O}_{2} + 2.5 {H}_{2} O$$

In particular, oxygen plays an important role in that process because it helps to oxidise, for example, Ni²⁺ to Ni³⁺. However, Ni³⁺ faces the problem of decomposition if the temperature prevailing in the roasting kiln is too high. Thus, the ternary cathode material could easily be decomposed at high or too high temperatures. Hence, the roasting process should keep its temperature as low as possible to make sure that Ni³⁺ will not undergo decomposition. A further object is to provide a uniform temperature distribution and/or a uniform atmosphere inside the kiln in order to avow all the raw material in the kiln to be exposed to the same process conditions.

According to the invention, injection of a gas component of the atmosphere, preferably oxygen, into the roasting kiln is controlled in closed loop control manner, i.e. by a closed loop control, based on at least one process influencing parameter being measured. In particular, the closed loop control is performed automatically by means of a centre module or the like.

Such process influencing parameter can be any parameter that influcences the process. Preferably, the at least one process influencing parameter is chosen from parameters characterizing the raw material, e.g., the specific composition of the raw material, and/or characterizing the atmosphere, e.g., the gas components present (like oxygen, carbon dioxide) and their specific ratios or a humidity, and/or characterizing the ternary cathode material, e.g., its specific composition. In order to measure such parameters corresponding measurement and/or analysing means can be provided at an appropriate position.

Advantageously, a gas injection lance is used for injection of the gas component in one or more zones of the roasting kiln. In particular, the gas injection lance is installed or provided at a roof or a sidewall of the roasting kiln. In case of more than one zone, one of those gas injection lances can be used for each zone. Also, two or more of those gas injection lances can be used in one or more of the zones. The zones of the roasting kiln may be defined based on zones or areas with different process parameters like different zones with different temperature and/or different velocity for moving the raw material through the roasting kiln. Such gas injection lances allow for very precise injection and, in consequence, very uniform contribution of gas in the roasting kiln. Zones, however, may also be assigned to saggars present in the roasting kiln.

For example, the gas injection lance (or each of several gas injection lances) is provided with one or more nozzles having a predetermined direction. The predetermined direction can preferably be chosen between 0° and 90° with respect to a longitudinal axis of the roasting kiln. In that way, the atmosphere and, in particular, the gas injected can be allowed to move towards a desired direction. Also, turbulences or gas flow movement can be generated by that.

Preferably, the gas component is provided to the gas injection lance with a pressure between 0.5 bar and 10 bar. That allows choosing the velocity with which the gas leaves the lance or its nozzle. For example, the velocity can reach up to sound speed.

Advantageously, at least part of the gas injection lance (or each of several lances) is made of material like steel (stainless steel or heat resisting alloy and the like) coated with ceramic or the gas injection lance (or each of several lances) is made of ceramic. Such ceramic, in particular in case of its use as coating, can be Al₂O₃, ZrO, SiC and the like, in particular with very high purity, in order not to allow any direct contact of the material like steel or other metal parts with the atmosphere in the kiln.

The proposed method allows oxygen, which is required for such process, to be exposed to the raw material very uniformly. In case of several saggars present in the kiln, for example, every saggar can be exposed to sufficient oxygen. Without such method, however, less contact of raw material with oxygen was seen in the inner saggars. The raw material in the outer saggers, in contrast, was seen to have better chances to get in contact with oxygen. Thus, the quality of the roasting was not as good for the raw material in the inner saggars or saggar lines. The layer thickness of raw material had to be made very thin. These disadvantages can be overcome with the proposed method.

The proposed method further allows to improve the quality of ternary cathode material for lithium battery production, to improve the quality stability of such ternary cathode material and to keep the oxygen level (or level of other gas components) stable in order to meet roasting process requirement for specific material in each zone of the kiln. Also, a possibility of production capacity improvement is provided. Energy consumption and flow gas volume can be reduced.

It is to be noted that the proposed method also can be used for transforming other raw material into corresponding products by means of such roasting kiln. For example,

Lithium Iron Phosphate (LFP) cathode material, or graphene anode material can be produced from corresponding raw material.

A further object of the invention is an apparatus for producing a ternary cathode material for lithium ion batteries, including a roasting kiln in which an atmosphere and raw material to be roasted can be provided. The apparatus also includes injection means for injection of a gas component of the atmosphere into the roasting kiln, and control means for controlling injection of the gas component in closed loop control manner, based on at least one process influencing parameter being measured. Measurement means can be provided for measuring such parameter. The injection means preferably include one ore more gas injection lances, the gas injection lance having a nozzle at its end, the nozzle having a predetermined direction between 0° and 90°, preferably between 20° and 70°, with respect to a longitudinal axis of the gas injection lance. Preferably, the apparatus is adapted for carrying out a method according to the invention.

With respect to further embodiments and advantages of the apparatus according to the invention it is referred to the statements above in order to avoid repetition.

The invention will now be further described with reference to the accompanying drawings, which show a preferred embodiment.

### BRIEF DESCRIPTION OF THE DRAWINGS

FIG. 1 schematically shows an apparatus, with which the method of the present invention can advantageously be implemented.

FIG. 2 schematically shows a gas injection lance as a part of the apparatus of FIG. 1 in more detail,

FIG. 3 shows the gas injection lance of FIG. 2 in a different view.

### DETAILED DESCRIPTION OF THE DRAWINGS

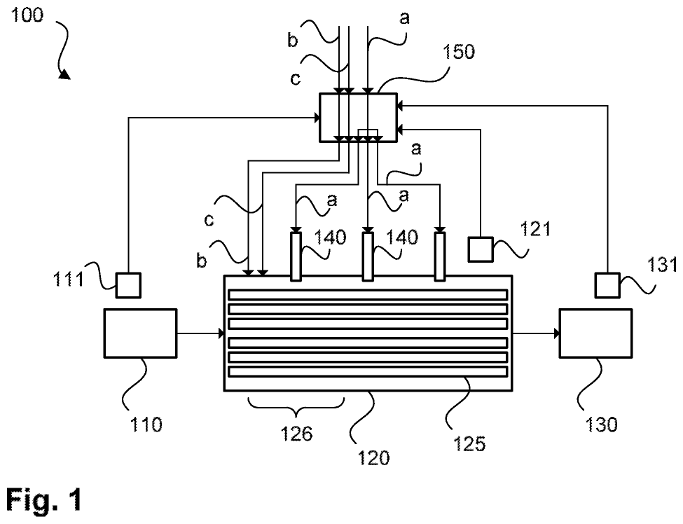

In FIG. 1, an apparatus 100 according to the invention in a preferred embodiment is shown. Such apparatus can be used and be adapted for carrying out a method according to the present invention. In the following, the apparatus and the corresponding method will be described together.

Apparatus 100 includes a roasting kiln 120, for example, in the form of a continue roller hearth kiln, by means of which raw material 110 is roasted in order to obtain ternary cathode material 130. The raw material 110 can be fed into the roasting kiln 120, in the roasting kiln 120 the raw material can be moved in saggar lines 125, for example.

During the time the raw material is moving inside the roasting kiln 120 it is roasted and undergoes a transformation into the desired ternary cathode material 130. With respect to the transformation, it is referred to the formulas mentioned above. After the raw material has been fully transformed at the end of the roasting kiln 120, the product, i.e. the ternary cathode material 130, can be removed from the kiln.

In the roasting kiln 120, an atmosphere is provided, the atmosphere including different gas components like (pure or mostly pure) oxygen, air and flue gas. By way of example, oxygen or an oxygen feed is denoted by numeral a, air or an air feed is denoted by numeral b and flue gas (like nitrogen) or a flue gas feed is denoted by numeral c.

These gas components a, b and c are fed to the inside of roasting kiln 120 via a control means or control module 150. By means of control module 150, the flow of each of those gas components can be controlled.

In the embodiment shown, oxygen a is fed into the roasting kiln 120 via three gas injection lances 140, provided, by way of example, in different zones 126 along the moving path of the raw material in the roasting kiln 120. Control module 150 can be adapted such that oxygen a (i.e. its mass flow), which is provided to the control module, can be distributed between these three gas injection lances 140 by a predetermined and variable ratio.

In order to determine a currently preferred ratio of the oxygen flow between the gas injection lances 140 on the one hand and an absolute mass flow of oxygen for each of the gas injection lances on the other hand, different parameters that influence the roasting process can be measured and fed to the control module in order to establish a closed loop control.

By way of example, a measuring and/or analyser means 111 for measuring or analysing a parameter characterizing the raw material 110, a measuring and/or analyser means 121 for measuring or analysing a parameter characterizing the atmosphere and a measuring and/or analyser means 131 for measuring or analyzing the ternary cathode material 130 are provided. Each of those means can feed the measurement or analysis results, in the form of a signal, to the control module 150 such that these results can be used to change (or keep) the oxygen flow.

It is to be noted that also the flows of air b and/or flue gas c can be changed in the same way if necessary or expedient. Besides, also the pressure of the roasting kiln atmosphere can be measured and controlled.

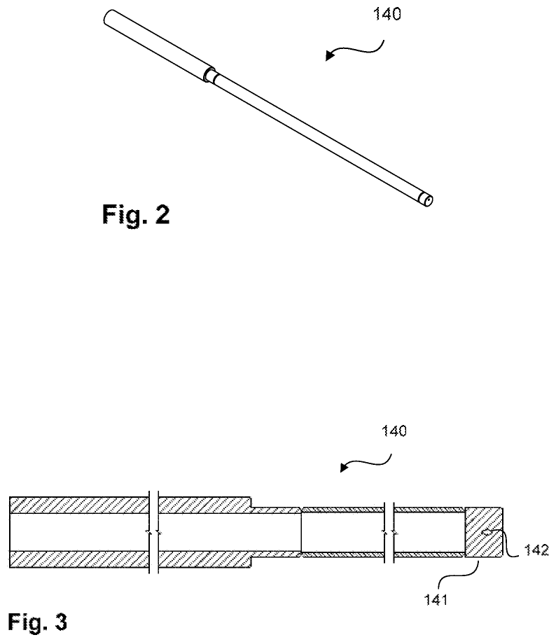

In FIG. 2, a gas injection lance 140 which is a part of the apparatus 100 of FIG. 1 is shown in more detail and in a perspective view. In FIG. 3, the gas injection lance 140 of FIG. 2 is shown in a sectional view.

From the left end, oxygen can be supplied to the gas injection lance 140. As this lance 140 is fed into the roasting kiln 120, the oxygen can be transferred into the kiln. At the right or inlet end 141, the gas injection lance 140 comprises a nozzle 142. This nozzle 142 is provided in the form of a channel with a certain angle with respect to the longitudinal direction or axis of the gas injection lance 140 (and, preferably, also with respect to other directions).

By means of such nozzle (also several nozzles can be provided at a lance) oxygen can be injected into the roasting kiln with a desired speed and with a desired direction. The final direction the oxygen is injected with is determined by the orientation of the nozzle (or channel) 142 in the gas injection lance 140, and by the orientation the gas injection lance 140 is arranged with in the roasting kiln 120.

As has been mentioned before, the gas injection lance 140 can be made of ceramic material or of steel (or stainless steel) covered with such ceramic. Basically, only the part of the lance to be placed inside the roasting kiln needs to be covered with or be made of ceramic or other like material in order to avoid damages due to oxidation.

By providing a desired number of such lances and providing these lances with a desired orientation (with respect to their nozzles), a very uniform distribution of oxygen in the roasting kiln 120 or its atmosphere can be achieved. As a result, ternary cathode material can be produced in a better and more efficient way.

1. A method for producing a ternary cathode material for lithium batteries by roasting raw material in a roasting kiln, wherein an atmosphere is provided in the roasting kiln,
wherein injection of a gas component of the atmosphere into the roasting kiln is controlled in closed loop control manner, based on at least one process influencing parameter being measured.

2. The method according to claim 1, wherein a gas injection lance is used for injection of the gas component in one or more zones of the roasting kiln.

3. The method according to claim 2, wherein the gas injection lance is provided with one or more nozzles having a predetermined direction.

4. The method according to claim 3, wherein the predetermined direction is chosen between 0° and 90° with respect to a longitudinal axis of the roasting kiln.

5. The method according to claim 2, wherein the gas component is provided to the gas injection lance with a pressure between 0.5 bar and 10 bar.

6. The method according to claim 2, wherein the gas injection lance is, at least in part, made of material coated with ceramic or is made of ceramic.

7. The method according to claim 1, wherein the at least one process influencing parameter is chosen from parameters of the raw material and/or the atmosphere and/or the ternary cathode material.

8. The method according to claim 1, wherein the gas component of the atmosphere is oxygen.

9. The method according to claim 1, wherein the ternary cathode material includes nickel cobalt manganese or nickel cobalt aluminum.

10. The method according to claim 1, wherein a continue roller hearth kiln or a pusher kiln is used as the roasting kiln.

11. An apparatus for producing a ternary cathode material for lithium ion batteries, including a roasting kiln in which an atmosphere and raw material to be roasted can be provided, the apparatus including injection means for injection of a gas component of the atmosphere into the roasting kiln, the apparatus further including control means for controlling injection of the gas component in closed loop control manner, based on at least one process influencing parameter being measured.

12. The apparatus according to claim 11, wherein the injection means include one or more gas injection lances, the gas injection lance having a nozzle at its end, the nozzle having a predetermined direction between 0° and 90°, preferably between 20° and 70°, with respect to a longitudinal axis of the gas injection lance, and/or the gas injection lance being installed at a roof or a sidewall of the roasting kiln.

13. (canceled)

14. An apparatus for producing a ternary cathode material for lithium ion batteries, including a roasting kiln in which an atmosphere and raw material to be roasted can be provided, the apparatus including injection means for injection of a gas component of the atmosphere into the roasting kiln, the apparatus further including control means for controlling injection of the gas component in closed loop control manner, based on at least one process influencing parameter being measured, the apparatus being adapted for carrying out the method according to claim 1.
